(19) United States
(12) Patent Application Publication
(10) Pub. No.: US 2016/0278105 A1
(43) Pub. Date: Sep. 22, 2016

(54) METHODS AND APPARATUS FOR REDUCING CALL SETUP DELAY FOR A WIRELESS DEVICE

(71) Applicant: QUALCOMM Incorporated, San Diego, CA (US)

(72) Inventors: Alvin Siu-Chung Ng, Hong Kong (HK); Chun Chung Patrick Chan, Hong Kong (HK); Tsun Sang Cheong, Hong Kong (HK); Tak Wai Wu, Hong Kong (HK)

(21) Appl. No.: 14/664,110

(22) Filed: Mar. 20, 2015

(51) Int. Cl. H04W 72/08; H04W 60/04; H04W 76/04; H04W 68/00

(52) U.S. Cl. CPC H04W 72/085; H04W 68/005; H04W 60/04; H04W 76/046

(57) ABSTRACT

Disclosed are methods and apparatus for reducing a call setup time in wireless communication systems, particularly for systems employing SVLTE where an LTE network is used for data and a 1×CDMA network for voice. The methods and apparatus feature the capability during mobile terminated (MT) calls to modify a normal mode of operation of a predefined operation in a mobile terminal (e.g., call switched fallback (CSFB)), wherein processes normally performed for between a first network (e.g., LTE) are not performed in the mobile terminal, allowing a page response message to be sent directly, and thus sooner, to the other network (e.g., 1×CDMA) in response to an MT call page. This hybrid operation allowing the skipping of normal processes reduces the time for call set up.

### BACKGROUND

1. Field

The present disclosure relates generally to methods and apparatus for reducing call setup delay for a wireless device, and more specifically to reducing call set up delay for a CDMA 1× Mobile Terminated (MT) call in a Simultaneous Voice and Long Term Evolution (SVLTE) device.

2. Background

Simultaneous Voice and Long Term Evolution (SVLTE) is a protocol and technical standard that allows a mobile wireless device, such as a mobile station (MS), mobile terminal, or user equipment (UE), to use both voice and data networks simultaneously. For example, SVLTE allows simultaneous use of CDMA 3G (e.g., CDMA 1×) for voice and LTE (4G.) for data, with the LTE and CDMA 1× domains being simultaneously managed in an SVLTE device.

When a mobile terminated (MT) call (i.e., a call received on a mobile device (MS or UE)) in CDMA 1× is setup, there is a set up delay (i.e., a Call Setup Delay) that occurs. The delay results from a number of steps that occur during the call setup. These steps include (1) the procedure of a base transceiver station (BTS) transmitting a page to the mobile station (MS) and the MS successfully receiving the page; (2) the MS updating an Overhead Message and accessing the network (i.e., sending a Page Response); and (3) the traffic channel (TCH) setup. It is noted that the first of these steps is referred to as the “Paging Delay,” and is unique to an MT call and adds further delay over the second and third steps, which are essentially common to and equal for both MT and mobile originated (MO) calls. The delay due to the second and third steps can then be referred to as the MO Call Setup Delay, which is common to both MT and MO calls. Thus, in general, the MT Call Setup Delay can be estimated according to the following relationship: MT Call Setup Delay=Paging Delay+MO Call Setup Delay.

The Paging Delay in MT calls is dependent on the slot cycle index (SCI) for the Paging Channel in the system. In CDMA 1×, for example, the Paging Channel (i.e., a shared channel that all MS's listen for various information including pages), is divided into “slots”. To conserve power, MS's that are idle will only “wake up” and listen for messages on the Paging Channel during their assigned slots. The SCI determines how frequently the MS's assigned slot occurs in a network. For example, if the SCI=0, the MS wakes up every 1.28 seconds, if the SCI=1, the MS wakes up every 2.56 seconds, and so on up to a typical maximum value of 7 (i.e., 163.84 seconds). It is evident then that the larger the SCI value, the more power that will be conserved in the MS, but the longer it will take to page the MS for an incoming call. Furthermore, it is noted that, on average, the Paging Delay is roughly half of the SCI. This means that the average Paging Delay is approximately 2.56 seconds for a network running with an SCI=2, with the worst case being 5.12 seconds, which is considered long.

It is further noted that for SVLTE devices, the paging process for MT calls follows the traditional CDMA 1× call set up procedure described above, including CDMA 1× paging, and the setting of the SCI index. Thus, given the tradeoff between call setup delay times and power conservation in a MS employing SVLTE, there is therefore a need in the art for methods and apparatus for such devices that afford good power conservation through the use of a longer SCI value, while at the same time further reducing the Paging Delay time.

### SUMMARY

According to an aspect, a method for reducing a call setup time in a wireless communication system is disclosed. The method includes establishing attachment and registration of a mobile terminal with a first radio access network and a second radio access network, and receiving a call page in a mobile terminal from the first radio access network for a mobile terminated call via a second radio access network. Additionally, the method includes modifying a normal mode of operation of a predefined operation in the mobile terminal wherein messaging between the mobile terminal and the second network processes normally performed according to the predefined operation are not performed in the mobile terminal. The method further includes sending a page response message to the first radio access network in response to the call page, and then establishing the mobile terminated call between the mobile terminal and the first radio access network according to predefined procedures particular to the first radio access network for mobile terminated call set up.

In another aspect, an apparatus for reducing a call setup time in a wireless communication system is disclosed. The apparatus features means for establishing attachment and registration of a mobile terminal with a first radio access network and a second radio access network, and means for receiving a call page in a mobile terminal from the first radio access network for a mobile terminated call via a second radio access network. Further, the apparatus includes means for modifying a normal mode of operation of a predefined operation in the mobile terminal wherein messaging between the mobile terminal and the second network processes normally performed according to the predefined operation are not performed in the mobile terminal. Moreover, the apparatus includes means for sending a page response message to the first radio access network in response to the call page, and means for establishing the mobile terminated call between the mobile terminal and the first radio access network according to predefined procedures particular to the first radio access network for mobile terminated call set up.

According to still another aspect, an apparatus for reducing a call setup time in a wireless communication system is disclosed. The apparatus features at least one processor that is configured for establishing the attachment and registration of a mobile terminal with a first radio access network and a second radio access network, an receiving a call page in a mobile terminal from the first radio access network for a mobile terminated call via a second radio access network. The at least one processor is further configured for modifying a normal mode of operation of a predefined operation in the mobile terminal wherein messaging between the mobile terminal and the second network processes normally performed according to the predefined operation are not performed in the mobile terminal. Additionally, the at least one processor is configured for sending a page response message to the first radio access network in response to the call page, and establishing the mobile terminated call between the mobile terminal and the first radio access network according to predefined procedures particular to the first radio access network for mobile terminated call set up.

### BRIEF DESCRIPTION OF THE DRAWINGS

FIG. 1 is an illustration of an exemplary environment in which the presently disclosed methods and apparatus may implemented.

FIG. 2 is a message/call flow diagram of a conventional Circuit Switched Fallback (CSFB) operation.

FIG. 3 is an exemplary message/call flow diagram of a modified or hybrid operation according to the presently disclosed methods.

FIG. 4 is a flow diagram of an exemplary method for reducing call set up in a wireless device.

FIG. 5 is another exemplary message/call flow diagram of a modified or hybrid operation according to the presently disclosed methods for further reducing call set up time.

FIG. 6 is a plot of SCI values with regard to Reference Signal Received Power (RSRP) showing the use of multiple thresholds to avoid frequent back and forth oscillation between the setting of a longer SCI and a normal SCI.

FIG. 7 is a flow diagram showing an exemplary method for modifying the SCI value in a wireless device.

FIG. 8 is a flow diagram showing another exemplary method for modifying the SCI value in a wireless device

FIG. 9 is a block diagram of an exemplary apparatus according to the presently disclosed apparatus.

FIG. 10 is a block diagram of another exemplary apparatus according to the presently disclosed apparatus.

### DETAILED DESCRIPTION

The present disclosure recognizes that for 3GPP and 3GPP2 specifications, a technology termed “Circuit Switched FallBack” (CSFB) was specified whereby voice and messaging (e.g., SMS) services are delivered to LTE devices through the use of another circuit-switched network, such as CDMA 1× or GSM. For example, in 1×CSFB when a User equipment (UE) or mobile terminal is camped on an LTE network, it needs to “fall back” to the Circuit Switched (CS) domain when a voice call is initiated or received. CS fallback from LTE (i.e., evolved UMTS Terrestrial Radio Access (E-UTRAN)) to CDMA 1× enables the delivery of CS-domain services by reuse of the CDMA 1× infrastructure when the UE is served by E-UTRAN. In 1×CSFB, the paging procedure is performed in the LTE domain, and is known to be much faster than in the CDMA 1× domain. Even if a re-page is required, for example, the additional delay is still much less than the paging delay in the CDMA 1× domain, with delays typically being less than one second. Accordingly, the present disclosure provides methods and apparatus that utilize at least a portion of a paging procedure in the LTE domain in an SVLTE device to reduce the Call Setup Delay for MT calls, while also using a portion of 1×CSFB procedure, thus allowing a greater SCI value in the CDMA 1× domain for greater power conservation.

As will be explained in more detail below, according to one aspect the present methods and apparatus achieve a reduction in Call Setup Delay for an SVLTE UE by modifying the normal SVLTE call paging and set up operation using traditional CDMA 1× processes, to become a modified or “hybrid” operation that employs part of the normal SVLTE call set (i.e., CDMA 1× call paging and call set up), as well as using 1×CSFB processes employing LTE processes that will reduce the call set up time when establishing a 1×MT call. This hybrid approach is based on assumption that the network supports 1×CSFB procedures such that the 1×CSFB can be capitalized upon. According to another aspect of the present methods and apparatus, further beneficial reduction of Call Setup Delay can be achieved by configuring the hybrid process to skip further normal CSFB call set up processes during certain situations, such as after Radio Resource Control set up has already been effected for a UE.

In other aspects, it is noted that further power reduction in a UE may be realized through use of the disclosed hybrid procedures through increasing the SCI index value or even eliminating the use of an SCI index.

For purposes of the following discussion, it is noted that the word “exemplary” is used herein to mean “serving as an example, instance, or illustration.” Any example described herein as “exemplary” is not necessarily to be construed as preferred or advantageous over other examples. Additionally the terms “CDMA 1×”, “1×RTT”, and “1×” may be used interchangeably herein to denote any one of the various iteration of CDMA2000 1× standards or technologies.

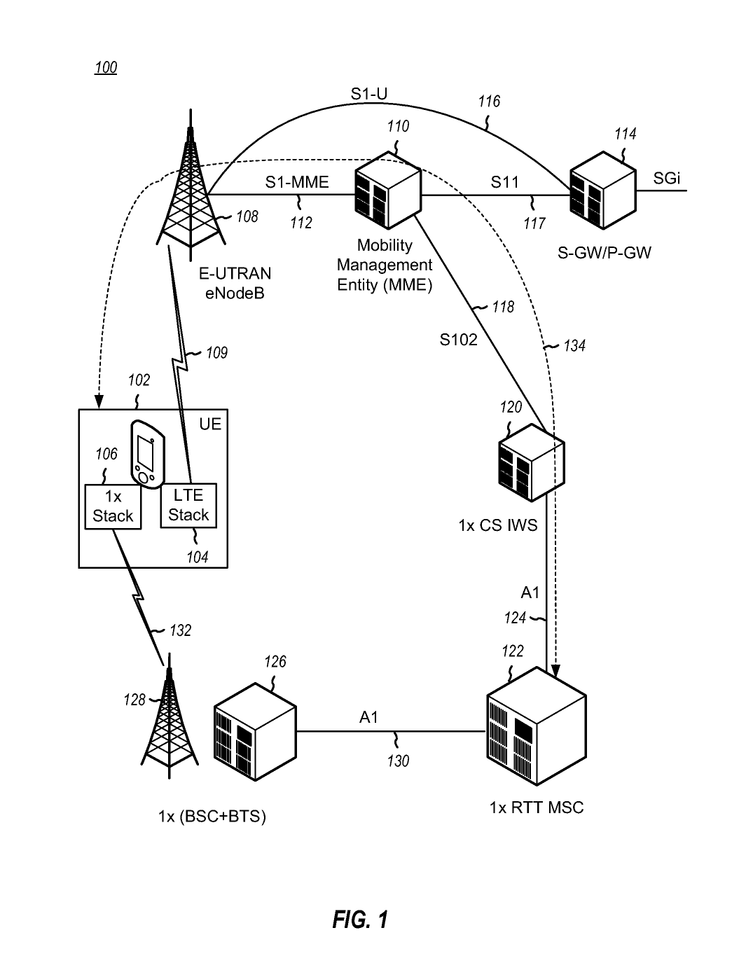

Turning to FIG. 1, this figure illustrates an exemplary contextual environment 100 in which CSFB and SVLTE devices operate that may employ the disclosed methods and apparatus. As illustrated, the environment 100 includes a UE 102 that is an SVLTE device operable in both LTE and CDMA 1× technologies, as illustrated by LTE stack 104 and CDMA 1× stack 106. It is noted at the outset, however, that it is conceivable that the present methods and apparatus may be applied to other types of UEs employable with other radio access technologies (RATs). That is, the presently disclosed call set up reducing and power saving methods and apparatus could be applied in other RATs where the mixed utilization of different portions of call set up procedures could afford realization of eliminating processes to reduce time, or, in the instance where one of the technologies uses an SCI or similar index, added power reduction capabilities by allowing cycling of power up of a UE to be reduced in frequency or extended in the periodicity.

The environment 100 further includes an E-UTRAN eNodeB 108 that effectuates wireless access for the UE 102 to an LTE radio access network via the LTE-Uu interface (109). The E-UTRAN 108 is in network communication with core network (CN) elements in the LTE evolved packet core (EPC) including a Mobility Management Entity (MME) 110 via the S1-MME interface 112 and Serving and PDN Gateways (S-GW/P-GW) 114 via an S1 interface (S1-U 116). According to the EPC model, MME 110 also is in communication with S-GW/P-GW via an S11 interface 117. The core network is responsible for the overall control of the LTE UE and establishment of various bearers (i.e., a set of network parameters that define how UE data is treated when it travels across the network (e.g., providing a specific data rate for particular data, etc.)).

The MME 110, in particular, is the control node that processes the signaling between the UE 102 and the core network, but also processes signaling to other networks, such as a CDMA 1× network. The signaling between an LTE network and a CDMA 1× network is effectuated via an S102 tunnel or interface, as indicated in FIG. 1 by reference number 118. In particular, the S102 interface 118 is established between the MME 110 and an Interworking gateway (1×CS IWS 120) for access to the 1×CMDA network. The IWS 120 is in network communication with a 1×RTT Mobile Switching Center (MSC) server 122 via an A1 interface 124. The MSC 122 is in communication with various base station controllers (BSC), such as BSC 126 and associated base transceiver stations (BTS 128) via A1 interfaces 130. The BTS 128 communicates with the UE 102, and the 1× stack 106, in particular, via wireless interface 132.

Furthermore, FIG. 1 illustrates that a tunnel 134 exists between the UE 102 and the 1×RTT MSC 122 between the LTE side of UE 102 via the wireless interface 109, E-EUTRAN 108, S1 interface 112, MME 110, S102 interface 118, the IWS 120 and AI interface 124. This tunnel 134 allows messaging and data to be routed between the 1×RTT MSC 122 and the UE 102 via the LTE network.

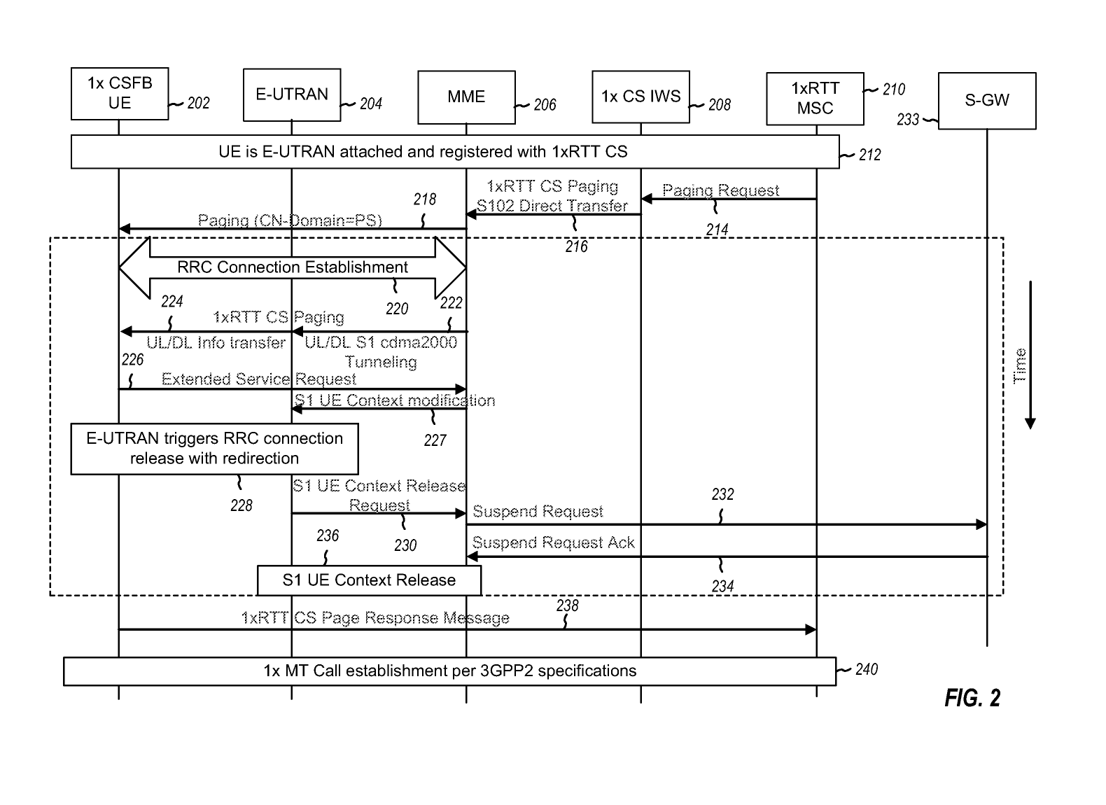

FIG. 2 illustrates a call flow diagram showing a conventional MT Call establishment procedure as set forth in TS 23.272 of the 3GPP specification. As may be seen, the MT call flow starts with a system where a UE 202 is E-UTRAN attached to an eNodeB (i.e., E-UTRAN 204). Additionally, via the core LTE network (e.g., Mobility Management Entity (MME) 206), the Interworking gateway (i.e., 1×CS IWS 208) between MME 206 and 1× Radio Transmission Technology mobile switching center server (i.e., 1×RTT MSC server 210), the UE 202 is preregistered with the 1×RTT CS network. This attached and preregistered state is illustrated with block 212 showing interconnected communication between the various network devices.

When an MT call occurs, the 1×MSC 210 sends a paging request 214 to the 1×CS IWS node 208. The 1×CS IWS node 208 forwards a 1×RTT CS paging request 216 via an S102 tunnel to the MME 206. It is noted that LTE uses the S102 tunnel or interface to transparently pass 1× signaling between the cdma2000 1× system and UE's.

If the UE 202 is in an idle state, it is noted that the MME 206 will perform a network initiated Service Request procedure in order to bring the UE 202 to an active state prior to tunneling of the 1×RTT CS paging request toward the UE 202. This process includes the a page where the core network is packet switched (218) and then a Radio Resource Control (RRC) connection is established between MME 206 and UE 202 as indicated by arrow 220.

MME 206 forwards a 1×RTT CS paging request to the UE through first an UL/DL (uplink/downlink) S1 cdma2000 tunneling 222 from MME 206 to the E-UTRAN 204 and then a UL/DL information transfer 224 from the E-UTRAN or eNodeB 204 to the UE 202. If the UE 202 accepts CS paging for the CS Fallback for 1×RTT, the UE 202 sends an Extended Service Request 226 (also known as a CS Fallback Indicator) to the MME 206.

Next, the MME 206 will indicate to the E-UTRAN 204 to move the UE 202 to 1×RTT. The MME 206 may cause the E-UTRAN 204 to trigger a move of the UE 202 to 1×RTT. Furthermore, although not shown in FIG. 2, the E-UTRAN 204 may optionally solicit a measurement report from the UE 202 to determine the target 1×RTT cell to which the CS Fallback will be performed.

Next, the MME 206 sends an S1 UE message 227 for UE Context Modification (UE capabilities, CS Fallback Indicator) to indicate to the E-UTRAN 204 to move the UE 202 to 1×RTT domain or context. The E-UTRAN 204 triggers RRC connection release as shown at block 228 with redirection to the 1×CS system. The E-UTRAN 204 then sends an S1 UE Context Release Request (Cause) message 230 to the MME 206. Message 230 indicates that the S1 UE Context Release was caused by CS Fallback to 1×RTT. The MME 206 sets the UE context to a suspended status and a Suspend Request message 232 sends to serving gateway (S-GW) 233 that requests the suspension of EPS bearers for the UE 202. The S1-UE bearers are released for all EPS bearers by the MME 206 and all Guaranteed Bit Rate (GBR) bearers are deactivated. The non-GBR bearers are preserved and are marked as suspended in a serving gateway (S-GW) 233. In response, the S-GW 233 responds to the Suspend Request message 232 with an acknowledgement message 234, and marks the UE 202 as suspended. When downlink data arrives at the S-GW, the S-GW should not send a downlink data notification message to the MME 206 if the UE 202 is marked as suspended.

The S1 UE Context in the E-UTRAN 204 is released as specified in the 3GPP specification as indicated at block 236. The UE 202 then tunes to 1×RTT and acknowledges the page by transmitting a 1×RTT CS Page Response message 238 to the 1×RTT MSC 210 over the 1× Access Channel. Subsequently the UE 202 performs the procedure for MT call establishment as specified in 3GPP2 specification. After the 1× voice call ends, the UE 202 will revert to an inactive state and the MMSS is triggered to reselect a best system (i.e., LTE). The UE 202 will return to LTE and perform tracking area (TA) updates. The UE 202 also may request 1×CSFB parameters from the E-UTRAN 204 and perform S102 preregistration.

According to an aspect of the present disclosure, methods and apparatus provide a hybrid procedure of normal operation of SVLTE devices (or similarly functioning devices) whereby the normal monitoring of 1× and LTE pages is modified. In particular, the monitoring of 1× paging may be disabled in a UE where the UE only will monitor the LTE connection for pages from the 1×RTT MSC. It is noted that this hybrid procedure is based on the assumption that CSFB capabilities are extant in the radio access networks with which the UE communicates. Thus, the CSFB procedure, or at least a portion of the procedure, may be utilized in this hybrid approach.

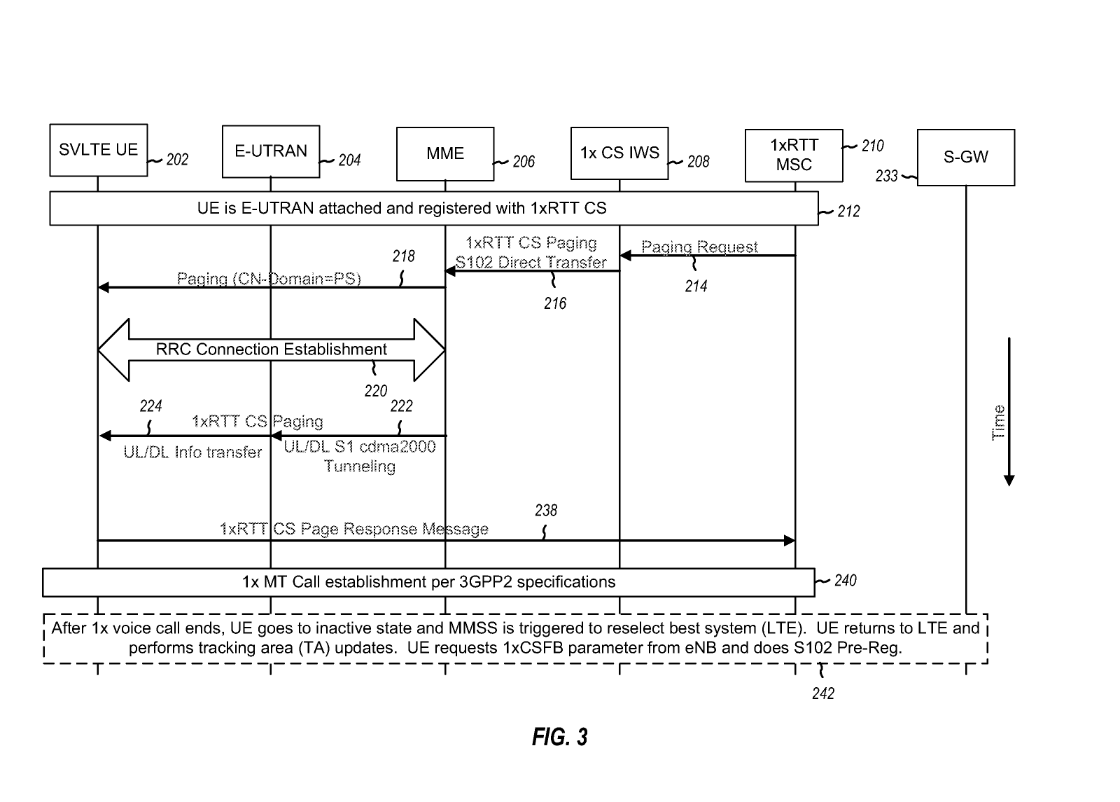

FIG. 3 illustrates a call flow diagram of a hybrid approach applicable to MT calls where an SVLTE device is either in a connected mode or an idle mode. It is noted that the reference numbers in FIG. 3 that are common to FIG. 2 denote the same elements or processes. As illustrated, FIG. 3 shows that the hybrid process involves the 1×RTT MSC 210 sending the Paging Request 214 to the IWS 208, and the IWS in turn sending the 1×RTT Circuit Switched (CS) Paging Request to the MME 206 via the S102 interface as shown by page message 216. If the UE is in idle mode, the RRC connection will need to be established. Thus, in this case the MME 206 will send a Packet Switched (PS) Page (i.e., the Core Network (CN) Domain is PS) 218 to the SVLTE UE 202. It is noted that at this moment in the process, the UE 202 will not yet know that the paging message is a MT voice page. The UE 202 will then establish an RRC connection with MME 206 to receive 1×RTT Circuit Switched (CS) Paging as illustrated by arrow 220.

Whether the UE is already connected and or was in idle mode requiring the further RRC connection establishment process, the MME 206 sends the 1×RTT CS Paging message (i.e., processes 222 and 224). It is noted here that, because of the presently disclosed hybrid process, the ESR and Context Release Procedures can be skipped. Thus, the attendant processes 226, 227, 228, 230, 232, 234, and 236 for ESR and Context Release are not shown in FIG. 3. The skipping of these processes result in improved call set up delay for the MT call. Accordingly, in response to the 1×RTT CS Paging message (222, 224), the UE 202 need only send a 1×RTT CS Page Response message 238 to the 1×RTT MSC 210. The 1×RTT network may then continue to 1×MT call establishment according to the 3GPP2 specifications as shown by process 240.

According to an aspect, the hybrid methodology of FIG. 3 is possible, in part, through a deactivating, stopping, pausing, or disabling of a normal mode of operation during MT calls for the monitoring of the 1×CDMA network by the UE, for example, as the SVLTE UE 202 will receive paging messaging through the LTE domain. Additionally, during the disclosed hybrid operational mode, the UE 202 can monitor LTE and support LTE traffic simultaneously. Thus, the ESR process and context release procedures of conventional CSFB shown in FIG. 2 are not needed.

It is noted that FIG. 2 also illustrates the processes occurring after a 1× voice call ends in block 242. In particular, after a 1× voice call ends, the UE 202 will return to an inactive state and the 3GPP2 process of Multimode system selection (MMSS) is triggered to reselect a best system (e.g., LTE), where MMSS is based on a set of parameters stored in the UE. Additionally, the UE 202 may return to LTE and perform tracking area (TA) updates, as well as request 1×CSFB parameters from the eNodeB (e.g., E-UTRAN 204) and perform S102 Pre-Registration.

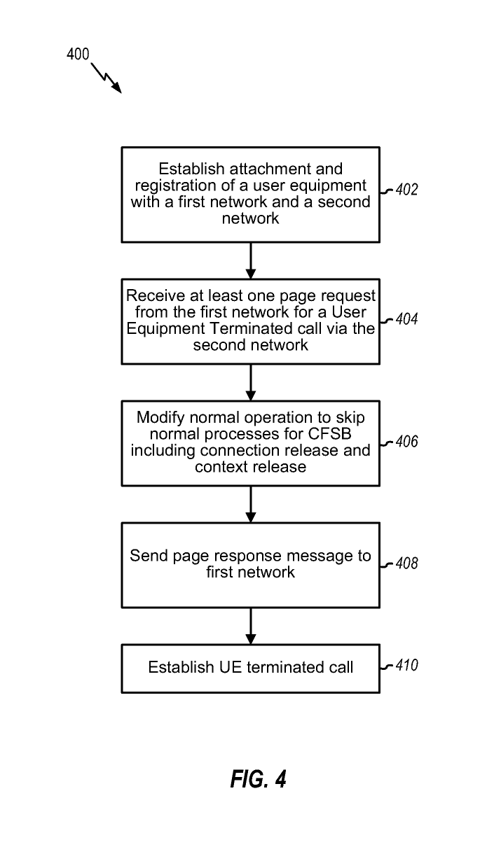

FIG. 4 illustrates a flow diagram of a method 400 for reducing the call set up time or latency in a wireless communication system or device according to an aspect. In particular, method 400 would be useful in a device having both LTE and 1×CDMA connectivity, although it is conceivable that the method could be applicable beyond just these two systems. For example, the method could be conceivably applied to a system where a device is attached and registered to both a first network and a second network, where one is a Circuit Switched (CS) network for voice (or conceivably even a Packet Switched (PS) network for voice) and the other is a PS network (or different PS network) for data. Furthermore, in this more generalized scenario, the MT paging for the first network would be capable of being switched to the second PS network, and there would be some type of fall back procedure such as 1×CSFB whereby MT calls are established for voice over the first network when the second network is not capable of handling voice calls.

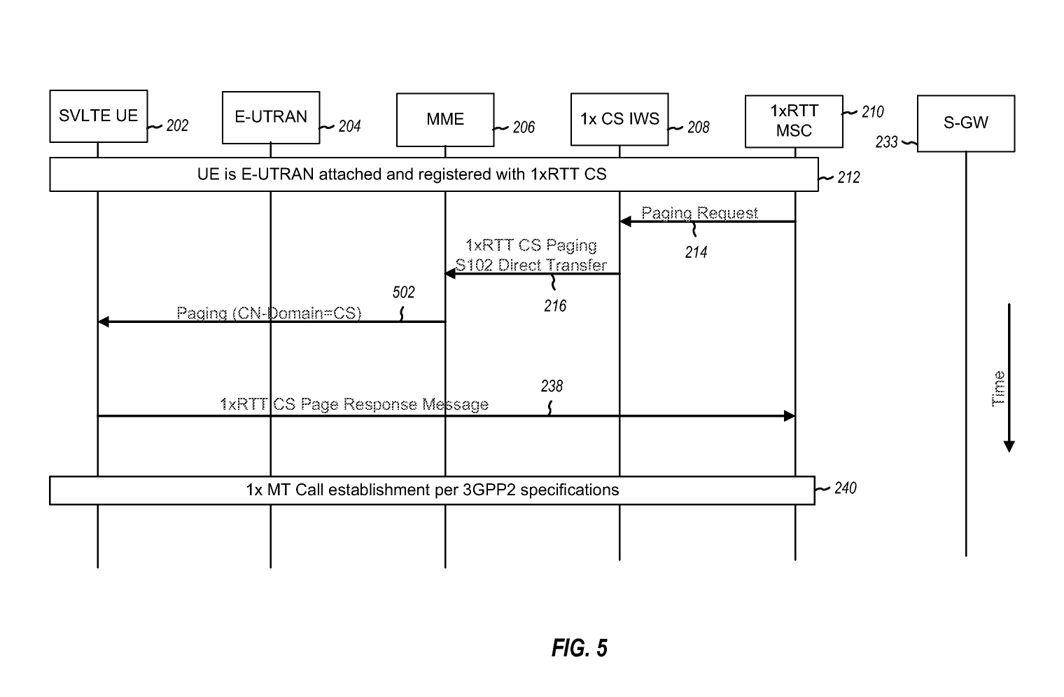

Accordingly, the method 400 first includes establishing attachment and registration of a user equipment with a first network (e.g., 1×RTT CDMA) and with a second network (e.g., LTE) as shown in block 402. After the combined attachment in block 402, the method 400 includes receiving at least one page request from the first network for a MT call (i.e., a call terminated at the UE) via the second network (e.g., an LTE network) as shown in block 404. It is noted that the switching domain of the page request message may be that of the second network (e.g., PS in the case of LTE) as illustrated in FIG. 3, but that the message may also be a different domain, as will be discussed later in connection with message 502 in FIG. 5. Method 400 also includes disabling or stopping of normal CSFB mode of operation of the UE (i.e., the “hybrid” mode discussed above) such that the ESR and Context Release are not executed as illustrated in block 406. It is noted that although the process of block 404 is shown sequentially in the methodology of FIG. 4, this process may be accomplished at the outset of method 400, after attachment to the first and second network (block 402), or even prior to the execution of the call set up procedure 400. In another aspect, the process of block 406 could be executed simultaneously or concomitantly with one or more of the processes of blocks 402 and 404.

As the hybrid mode or disabled normal mode is effectuated in the UE, after the CS Paging (e.g., 222, 224), the UE may then be configured to send or issue a page response message to the first network via the second network as illustrated by block 408 (e.g., UE 202 issues a 1×RTT CS Page Response Message (e.g., 238) tunneled via the E-UTRAN 204, the MME 206, the S102 interface, and the IWS 208 to the 1×RTT MSC 210 in a 1×CSFB Optimized approach). It is noted that, in an alternative not shown, rather than sending the page response via tunneling via the LTE network, the UE 202 may instead send the page response directly to the 1× network over the CDMA access channel. It is further noted here that in the case of FIG. 5, to be discussed below, even the waiting for CS paging 222, 224 may be eliminated, and simply the page response message 238 is sent or issued after paging by the MME 208. After the page response message is sent, then the UE establishes the MT call per specifications pertinent to the first network (e.g., 3GPP2 specification for 1×CDMA)\ as shown in block 410

In yet another aspect, it is noted that the further processes of the CSFB procedure may be skipped when the SVLTE UE is in an Idle Mode for a UE operating according to the presently disclosed hybrid process. This aspect is illustrated in FIG. 5, which shows the call flow for this further aspect. As illustrated by arrow 502 in FIG. 5, the MME 206 may send a paging message according to CS operation, not PS operation. When the SVLTE UE 202 receives the CS page, it is thus understood that the page originated with the 1×RTT network, not the LTE network. Thus, the SVLTE UE can skip the RRC establishment procedure (i.e., processes 220, 222, and 224 in FIG. 2) and directly respond with Page Response Message to the 1×RTT network for an MT call as illustrated by process 238. As described before, reduction of steps or processes specified for normal CSFB operation reduces the latency of the MT call set up.

As described above, after an SVLTE UE has registered to LTE domain for a combined attach to E-EUTRAN and 1×RTT CS (e.g., process 212 in FIGS. 2 and 3), the 1× paging message will go thru the LTE domain. At this point, the UE doesn't need to monitor the 1× network as frequently (or at all, in some aspects). Thus, in a further aspect, the SCI index may be configured to be a UE variable value that may be varied to be longer than conventional SCI values, such as those defined in the 3GPP2 specification. The advantage of using a longer duration of SCI is to consume less battery as the Hybrid SVLTE Mode UE discussed above doesn't need to receive pages from the 1×RTT paging channel (PCH). In a further aspect, a Hybrid SVLTE Mode UE would not need to monitor PCH messages delivered from 1×RTT PCH at all. Thus, the duration of the SCI index could be beyond the maximum standard defined value (i.e. SCI=7 or 163.84 seconds per cycle) or even configured not to be operable at all, theoretically speaking.

From a practical standpoint, it is noted that although higher SCI's are possible to use, consideration would likely need to be made when the UE should need to switch back to normal mode (normal SCI value), such as when the LTE network is unavailable or is degraded to a point that paging for the 1× network needs to be returned to the 1×PCH. Accordingly the UE can be configured with a fall back mechanism or process for going back to monitoring both 1× and LTE domain simultaneously for certain conditions. In an aspect, this process includes first determining that for predetermined qualitative and/or quantitative conditions, such as LTE unavailability or LTE degradation, the UE will switch back to the normal SCI index. A quantitative measure that can be used in making this determination, for example, is the Reference Signal Received Power (RSRP), which in LTE is the linear average of reference signal power across a specified bandwidth. Thus, in one example if the RSRP is greater or stronger than a certain predefined threshold level, the UE can utilize a longer SCI value (or no SCI value), whereas if the RSRP is at or below the predefined level the UE can be switched back to the normal SCI index value.

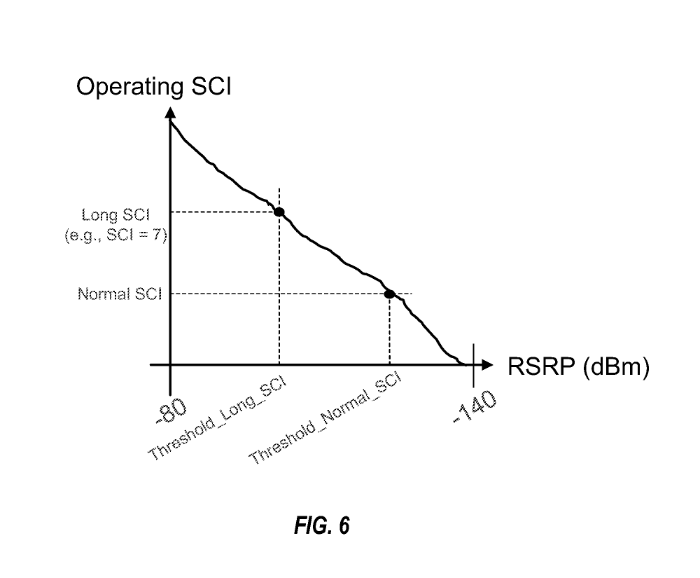

Of further note, if the RSRP is close to the threshold, frequent back and forth oscillation between a longer SCI and a normal SCI may occur. In such case, hysteresis can be incorporated into the process to mitigate frequent back and forth switching when the determined RSRP is close to the predefined threshold value. According to an aspect, at least two different thresholds may be established; one for when a UE is moving from good to poor coverage and the other when the UE is moving from poor to good coverage. As an example of this use of different RSRP thresholds, FIG. 6 illustrates a plot of the RSRP verses the operating SCI value to be set in a UE.

As illustrated in FIG. 6, a threshold for setting a long SCI (i.e., when a UE moves to good LTE coverage is designated as “Threshold_Long_SCI” value. In other words, when a UE has good LTE coverage, the hybrid process described above will be workable to allow the setting of a longer SCI index value. Accordingly, when the RSRP value becomes equal to or above (i.e., greater than, as the scale shown in FIG. 6 goes from a lesser negative value to a greater negative value)) the Threshold_Long_SCI value, the SCI for the UE may be set to a long value, such a SCI=7 (or even longer as discussed before).

Alternatively, when the UE moves from good LTE coverage to poor LTE coverage, another RSRP value designated as “Threshold_Normal_SCI” may be set such that as the RSRP equals or is below (i.e., less than) this value, the operation of the UE will fall back to a normal SCI value, such as SCI=2, for example. As will be appreciated by those skilled in the art, there is hysteresis in this process where the UE will not switch from a long SCI value to a normal SCI value until the RSRP value has deteriorated such that it is below the Threshold_Normal_SCI value, even though the RSRP has greatly dropped below the Threshold_Long_SCI value; and the UE will not switch from a normal SCI value to a longer SCI value until the RSRP improves such that it is greater than the Threshold_Long_SCI value even though the RSRP value has already substantially increased over the Threshold_Normal_SCI value.

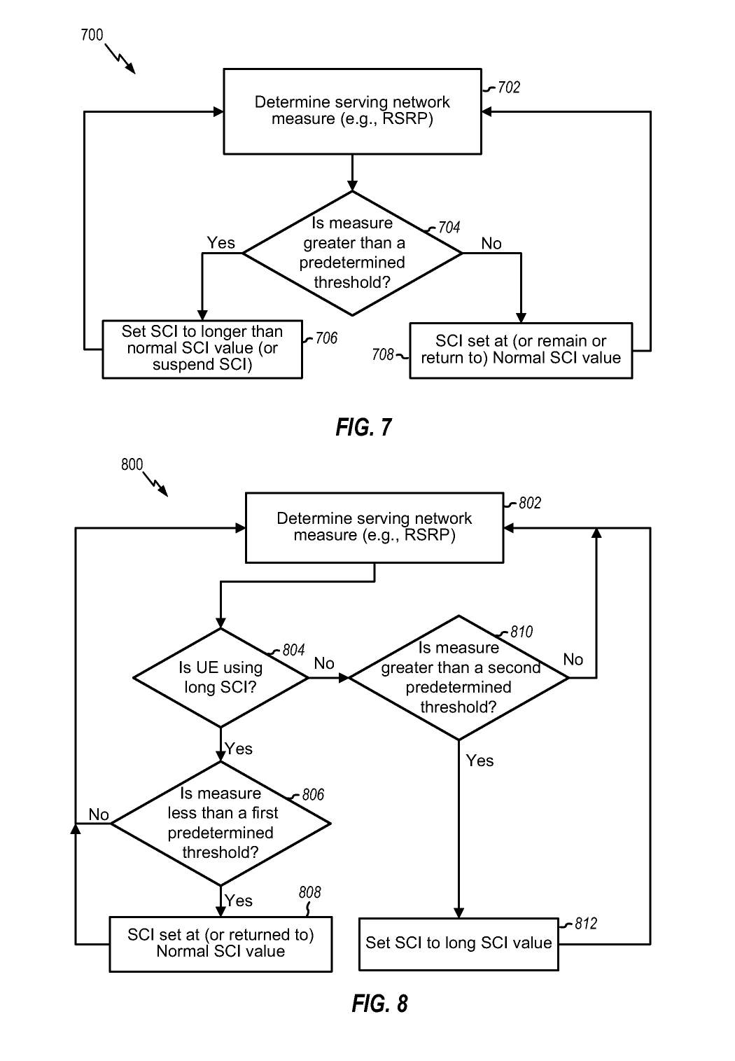

FIG. 7 illustrates an exemplary methodology 700 for modifying or adjusting the SCI value for a UE utilizing the hybrid mode procedures discussed above. Method 700 may include first determining a serving network quality or quantity measure or other parameter at block 702. For example, if the UE is being served by an LTE network, the measure could be the RSRP or other network qualitative or quantitative measures. If the measure is greater than a predetermined threshold as indicated by decision block 704 (i.e., the qualitative or quantitative measure is of a value being greater indicating that network is of good quality or strength) then flow proceeds to block 706. If yes, then flow proceeds to block 706 where the SCI value is increased to a longer than normal SCI value (e.g., SCI=7) or other timing longer than the greatest SCI value allows. Alternatively, if the condition of block 704 yields a negative, which indicates that the network is degraded, then flow proceeds to block 708 where the SCI is either set at, remains at, or returns to the normal SCI value.

FIG. 8 illustrates another exemplary method 800 for setting the SCI value that takes into account the concerns and methodology discussed above in connection with FIG. 6. In particular, method 800 includes first determining the serving network measure in the same manner as block 702 discussed above in connection with FIG. 7. Flow proceeds from block 802 to decision block 804 where a determination is made whether the UE is currently using a long SCI value. If the condition of block 804 is affirmative, then flow proceeds to block 806 to determine if the measure made at block 802 is less than a first predetermined threshold (e.g., Threshold_Normal_SCI as shown in FIG. 6). If not, the SCI value will remain set at the long SCI value and flow proceed back to block 802. If the measure is less than the first predetermined threshold, which indicates that the network is degraded, flow proceeds to block 808 where the SCI is set at (or returned to) the Normal SCI value for the UE and flow returning to block 802.

If the UE is not using the long SCI as determined at block 804, a determination is made at block 810 whether the measure is greater than a second predetermined threshold (e.g., Threshold_Long_SCI), the affirmative indicating an improving network quality. If the condition of block 810 is affirmative, then the SCI value is set to the long SCI value as indicated at block 812 and flow proceeds back to block 802. Alternatively at block 810, the measure does not indicate improvement or enough improvement as determined by the second threshold, then the SCI value will remain the normal SCI value and flow proceeds back to block 802.

One skilled in the art will appreciate that the condition of block 804 is simply making a determination between two possible states, i.e., whether a UE using a long SCI and a UE using a normal SCI. It is also contemplated, however, that more than two states could be considered to provide a higher degree of granularity of decision making, as well as allowing the setting of multiple different SCI's dependent on different ranges of the determined measure of the serving network.

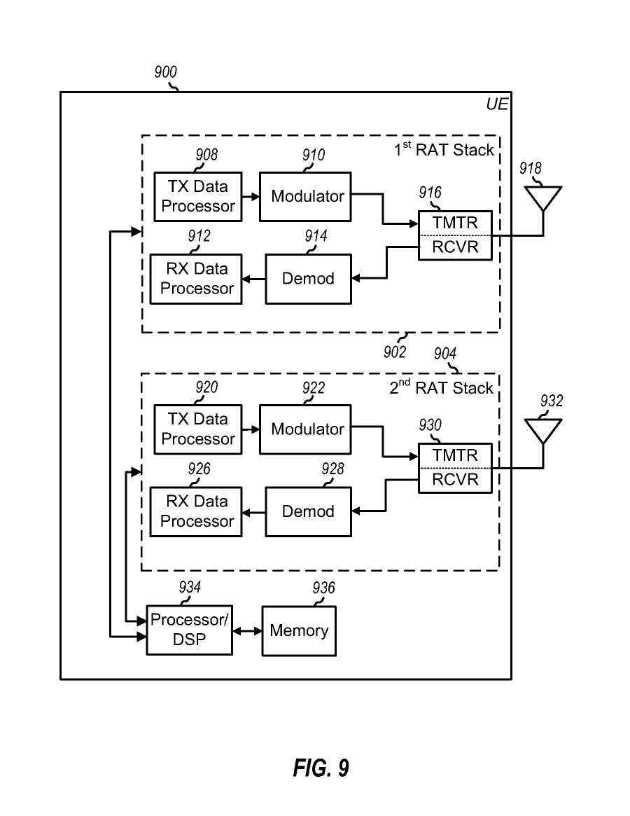

FIG. 9 illustrates a block diagram of an exemplary apparatus 900 that may implement the methods discussed above. In particular apparatus 900 may be a UE operable according to multiple RATs and including multiple modems for transmitting and receiving wireless signals from corresponding RATs. For example, apparatus 900 may be an UE including both a 1^{st} RAT stack 902 and a 2^{nd} RAT stack 904. As one skilled in the art will appreciate, the UE 900 may be an SVLTE UE, with application to the examples above that relate to LTE and 1×CDMA with CSFB capabilities, such that stack 902 could be an LTE stack and attack 904 could be a 1×RTT CDMA stack, wherein the UE

Each stack 902, 904 may include data processing and RF chains to transmit and receive data via the different RATs. Devices 902 and 904 are illustrated with processing (i.e., 908, 912, 920, 926) and RF (i.e., 910, 914, 916, 918 922, 928, 930, and 932) chains for purposes of illustrating the capability of communication according to at least two distinct RATs. It is noted, however, that the configuration of FIG. 9 is merely one example for illustration purposes, and that actual internal configurations of devices 902 and 904 that might be contemplated by those skilled in the art are varied and need not be configured as shown. For example, the architecture may be simplified such that one modem is configured with processing or modulation/demodulation to be shared among multiple RF Transmit/Receive circuits each performing their own associated baseband processing and RF conversions for transmission and reception.

In the configuration of FIG. 9, the apparatus 900 may include one or more processors and/or digital signal processing 934 along with an associated memory device(s) 936 that is configured to store computer-readable instructions or code accessible and executable by the processor(s) 934. The processor(s) 934 may control the operations of each of stacks 902 and 904, including determining the hybrid operation discussed above, as well as the operation for setting the SCI value for 1×CDMA operations when effectuating the hybrid mode operation.

In operation, the UE 900 may implement any of the processes or operations illustrated in FIGS. 3-8. In particular, the processor(s) 934 may be configured to implement these processes, and coordinate attendant operations and functions carried out by stacks 902 and 904, and their various components. It is also noted that the present apparatus and methods may be applied in devices operable with one or more RATs such as LTE and 1×CDMA, it is noted that application of the concepts disclosed herein may be made to LTE Advanced, 3GPP based systems, GSM, UMTS, HSPA, CDMA, 1×EVDO, W-CDMA, other 3G and 4G technologies, IEEE 802.11 WiFi, WiFi direct, WPAN (IEEE 802.15), WiMax (IEEE 802.16), WiGig, MBWA (IEEE 802.20), cognitive radio (IEEE 802.22), Bluetooth®, or various other mesh network systems such as IEEE 802.11s, as merely a few examples.

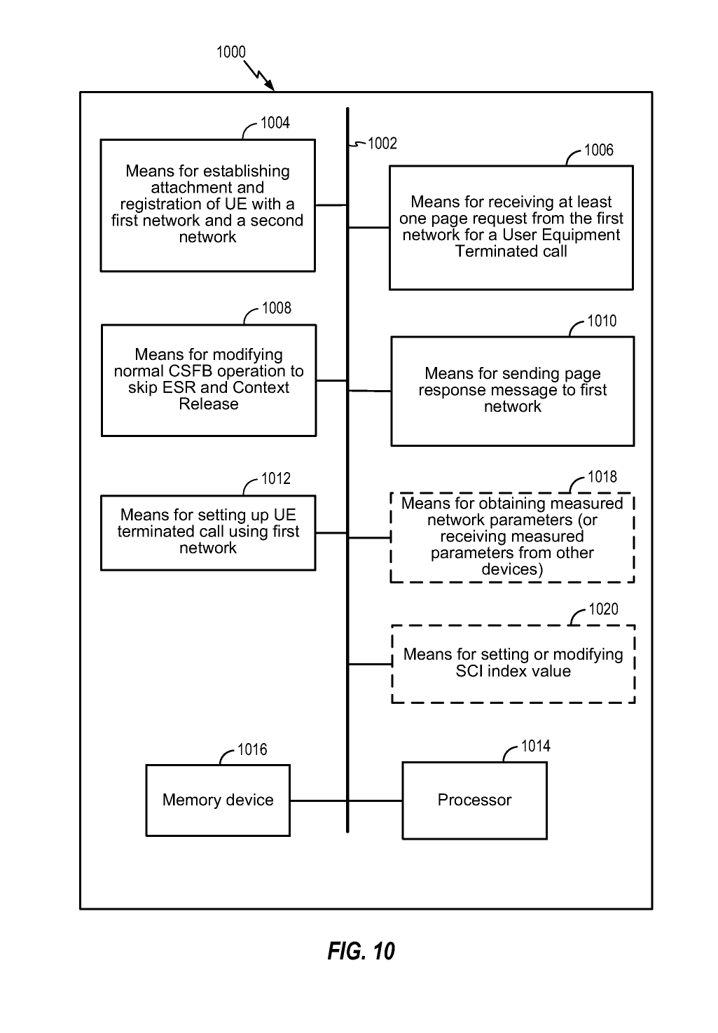

FIG. 10 illustrates another exemplary apparatus 1000 that may be used to implement the processes or operations of FIGS. 3-8. Apparatus 1000 is operable within a wireless device, such as UE 102 illustrated in FIG. 1 or UE 900 shown in FIG. 9. It is first noted that apparatus 1000 is illustrated with a communication bus 1002 merely to indicate that the various means, blocks, modules, or circuitry within apparatus 1000 are communicatively coupled and that communication of data and information occurs there between.

Apparatus 1000 may include a means or module 1004 for establishing attachment and registration of the user equipment with a first network and a second network. In a particular aspect, the first network may be a 1×CDMA network and the second network an LTE network. In a further aspect, means 1004 could be implemented by processor(s) 934 in FIG. 9, for example, and may also include stacks 902 and 904, and one or more of processors 908, 912, 920, and 926 therein or any other equivalent devices or structures for carrying out attachment and registration functions. Additionally, it is noted that means 1004 may configured to implement the process in block 402 of method 400.

The apparatus 1000 further includes a means or module 1006 for receiving at least one page request from the first network for a User Equipment Terminated call (i.e., an MT call). In an aspect, the MT call may be a 1×RTT call according to the 3GPP2 specification, although it is not necessarily limited to such. In a further aspect, means 1006 may be implemented by processor 934, as well as stacks 902 or 904, or any equivalent thereof capable of performing the functions. In a particular aspect, the stack 902 configured as an LTE stack may be included as part of means 1006 to receive the paging message from an MME 206 as shown by processes 218 or 502 in FIGS. 2 and 5, respectively. Additionally, it is noted that in an aspect means 1006 is configured to implement the process in block 404 of method 400, for example.

Further, apparatus 1000 includes means 1008 for disabling or modifying normal CSFB operation to skip at least ESR and Context Release processes in normal CSFB operations. In an aspect, means 1008 may be implemented by processor 934 as one example, and may also include components of stacks 902 or 904, or implemented by any equivalent structures capable of modifying or disabling CSFB. Furthermore, means 1008 may be configured or structured to effect the operations or processes of block 406 in method 400, for example. Means 1008 may also operate independently of the other means in apparatus 1000 by disabling or modifying CSFB operation either concomitantly or separately from the other functions performed by the other means or modules.

Apparatus 1000 also includes means 1010 for issuing a page response message to the first network via the second network. In one example, the page response message is a 1×RTT CS Page Response Message (e.g., 238 in FIGS. 3 and 5) that is sent via the LTE network (i.e., the second network including E-EUTRAN 204 and MME 206 tunneling to the 1×CS IWS 208) to the 1×RTT MSC (i.e., the first network), or alternatively sent directly to the 1× network over the CDMA access channel. It is noted that means 1010 may be implemented by the processor(s) 934 in FIG. 9, for example, in conjunction with one or more of stacks 902 and 904, and one or more of processors 908, 912, 920, and 926 therein or any other equivalent devices or structures for carrying out paging response. Additionally, it is noted that means 1010 may configured to implement the process in block 408 of method 400.

When means 1010 issues a page response, apparatus 1000 then utilizes means 1012 for setting up a UE terminated call (i.e., MT call) using the first network. The first network, in one example, is a 1×CDMA network, and the call set up would be effectuated according to the standard 3GPP2 specification provisions for MT calls, accordingly. Means 1012 may be implemented with by the processor(s) 934 in FIG. 9, for example, in conjunction with one or more of stacks 902 and 904, and one or more of processors 908, 912, 920, and 926 therein or any other equivalent devices or structures for carrying out paging response. Additionally, it is noted that means 1012 may configured to implement the process in block 410 of method 400.

In another optional aspect, apparatus 1000 may include also includes a general processor 1014 (or application specific processor in another aspect), which may perform any or all of the various functions of the various means of apparatus 1000 in association with a memory device 1016 used to store instructions executable by the processor 1014 to implement one or more various functions. It is noted that any of the means or modules in apparatus 1000 may be implemented with hardware, software, firmware, or any combination thereof, and may further be implemented separately as shown, or alternatively in an integral unit such as in a processor 1014 or a similarly equivalent device.

Still further, apparatus 1000 may include an optional means 1018 for either measuring network parameters or receiving measure parameters from other network devices. For example, means 1018 may determine (or receive measurements of) the RSRP of an LTE network, which are then used for setting or modifying the SCI index value when a UE associated with the apparatus 1000 is operating in the above-described hybrid mode. Means 1012 may be implemented with by the processor(s) 934 in FIG. 9, for example, as well as in conjunction with or including one or more of stacks 902 and 904, and one or more of processors 908, 912, 920, and 926 therein or any other equivalent devices or structures for carrying out paging response. Additionally, it is noted that means 1018 may configured to implement the processes in blocks 702 or 802 of the methods 700 and 800, respectively.

Associated with means 1018 is an optional means 1020 for setting or modifying the SCI index value of a UE in which apparatus 1000 is employed. In particular, means 1020 may be configured to implement various processes disclosed in methods 700 and 800. Means 1020 may be implemented with by the processor(s) 934 in FIG. 9, for example, as well as in conjunction with or including one or more of stacks 902 and 904, and one or more of processors 908, 912, 920, and 926 therein or any other equivalent devices or structures for carrying out paging response.

It is understood that the specific order or hierarchy of steps in the processes disclosed is merely an example of exemplary approaches. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

Those of skill in the art will understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill will further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description of the disclosed examples is provided to enable any person skilled in the art to make or use the presently disclosed methods and apparatus. Various modifications to these examples will be readily apparent to those skilled in the art, and the generic principles defined herein may be applied to other examples without departing from the spirit or scope of the invention. Thus, the present invention is not intended to be limited to the examples shown herein but is to be accorded the widest scope consistent with the principles and novel features disclosed herein.

What is claimed is:

1. A method for reducing a call setup time in a wireless communication system comprising:
establishing attachment and registration of a mobile terminal with a first radio access network and a second radio access network;
receiving a call page in a mobile terminal from the first radio access network for a mobile terminated call via a second radio access network;
modifying a normal mode of operation of a predefined operation in the mobile terminal wherein messaging between the mobile terminal and the second network processes normally performed according to the predefined operation are not performed in the mobile terminal;
sending a page response message to the first radio access network in response to the call page; and
establishing the mobile terminated call between the mobile terminal and the first radio access network according to predefined procedures particular to the first radio access network for mobile terminated call set up.

2. The method as defined in claim 1, wherein the first radio access network is a 1×CDMA network and the second radio access network is an LTE network.

3. The method as defined in claim 1, wherein the predefined operation is a circuit switched fallback (CSFB) operation.

4. The method as defined in claim 3, wherein the second network processes not performed in the mobile terminal include one or more of Extended Service Request processes, Context Release, RRC connection establishment, and

5. The method as defined in claim 1, wherein the paging message received from the second network is a packet switched domain message.

6. The method as defined in claim 1, wherein the paging message received from the second network is a circuit switched domain message.

7. The method as defined in claim 1, further comprising:
setting a slot cycle index (SCI) value to a longer than normal value when the normal mode is modified.

8. The method as defined in claim 1, further comprising:
determining a network parameter measure of the second network; and
setting the SCI value to a longer than normal value for the mobile terminal when the network parameter indicates that the quality or strength of the second network is acceptable for allowing the modification of the normal operation.

9. The method as defined in claim 1, further comprising:
determining a network parameter measure of the second network;
setting the SCI value to a longer than normal value when the network parameter measure exceeds a first predetermined threshold indicating that the second network is of sufficient quality or strength for allowing the modification of the normal operation of the mobile terminal; and
setting the SCI value to a normal SCI value when the network parameter measure is less than a second predetermined threshold indicating that the second network is of insufficient quality or strength for allowing modification of the normal operation of the mobile terminal, wherein the second predetermined threshold is less than the first predetermined threshold, wherein the first and second thresholds respectively relate to better quality or strength and lesser quality or strength of the second network.

10. The method as defined in claim 9, wherein the second network in an LTE network and the network parameter measure is at least a Reference Signal Received Power (RSRP).

11. A device configured for reducing a call setup time comprising:
at least one processor configured for:
establishing attachment and registration of a mobile terminal with a first radio access network and a second radio access network;
receiving a call page in a mobile terminal from the first radio access network for a mobile terminated call via a second radio access network;
modifying a normal mode of operation of a predefined operation in the mobile terminal wherein messaging between the mobile terminal and the second network processes normally performed according to the predefined operation are not performed in the mobile terminal;
sending a page response message to the first radio access network in response to the call page; and
establishing the mobile terminated call between the mobile terminal and the first radio access network according to predefined procedures particular to the first radio access network for mobile terminated call set up.

12. The device as defined in claim 11, wherein the first radio access network is a 1×CDMA network and the second radio access network is an LTE network.

13. The device as defined in claim 11, wherein the predefined operation is a circuit switched fallback (CSFB) operation.

14. The device as defined in claim 13, wherein the second network processes not performed in the mobile terminal include one or more of Extended Service Request processes, Context Release, RRC connection establishment, and

15. The device as defined in claim 11, wherein the paging message received from the second network is a packet switched domain message.

16. The device as defined in claim 11, wherein the paging message received from the second network is a circuit switched domain message.

17. The device as defined in claim 11, wherein the at least one processor is further configured for:
setting a slot cycle index (SCI) value to a longer than normal value when the normal mode is modified.

18. The device as defined in claim 11, wherein the at least one processor is further configured for:
determining a network parameter measure of the second network; and
setting the SCI value to a longer than normal value for the mobile terminal when the network parameter indicates that the quality or strength of the second network is acceptable for allowing the modification of the normal operation.

19. The device as defined in claim 11, wherein the at least one processor is further configured for:
determining a network parameter measure of the second network;
setting the SCI value to a longer than normal value when the network parameter measure exceeds a first predetermined threshold indicating that the second network is of sufficient quality or strength for allowing the modification of the normal operation of the mobile terminal; and
setting the SCI value to a normal SCI value when the network parameter measure is less than a second predetermined threshold indicating that the second network is of insufficient quality or strength for allowing modification of the normal operation of the mobile terminal, wherein the second predetermined threshold is less than the first predetermined threshold, wherein the first and second thresholds respectively relate to better quality or strength and lesser quality or strength of the second network.

20. An apparatus for reducing a call setup time in a wireless communication system comprising:
means for establishing attachment and registration of a mobile terminal with a first radio access network and a second radio access network;
means for receiving a call page in a mobile terminal from the first radio access network for a mobile terminated call via a second radio access network;
means for modifying a normal mode of operation of a predefined operation in the mobile terminal wherein messaging between the mobile terminal and the second network processes normally performed according to the predefined operation are not performed in the mobile terminal;
means for sending a page response message to the first radio access network in response to the call page; and
means for establishing the mobile terminated call between the mobile terminal and the first radio access network according to predefined procedures particular to the first radio access network for mobile terminated call set up.
